(19) United States
(12) Patent Application Publication
(10) Pub. No.: US 2026/0017340 A1
(43) Pub. Date: Jan. 15, 2026

(54) GRAPH INVESTIGATION AND IDENTIFICATION SYSTEM

(71) Applicant: Bank of America Corporation, Charlotte, NC (US)

(72) Inventor: Justin Horowitz, Fort Mill, SC (US)

(21) Appl. No.: 18/766,907

(22) Filed: Jul. 9, 2024

(51) Int. Cl. G06F 17/16

(52) U.S. Cl. CPC G06F 17/16

(57) ABSTRACT

Methods for identifying subsets of entities within a plurality of entities are provided. Methods may receive indication of an action, receive a plurality of attributes and receive the plurality of entities. Methods may use a search algorithm to link, using one or more selected attributes, included in the plurality of attributes, the action and/or one or more selected entities, included in the plurality of entities, to one or more other selected entities, included in the plurality of entities Methods may create a graph of the selected entities and the selected attributes. The plurality of entities may correspond to a plurality of nodes within the graph. The selected attributes may correspond to edges within the graph. Each entity included in the selected entities may be represented by a node on a graph. Each attribute included in the selected attributes may be represented by an edge on the graph.

### FIELD OF TECHNOLOGY

Aspects of the disclosure relate to artificially intelligent investigation systems.

### BACKGROUND OF THE DISCLOSURE

Recently, stored data has been growing at an exponential rate. The quantity of stored data grows with each day as entities use electronic devices, such as computers, smartphones, tablets and other suitable devices. As such, large quantities of data are readily available. Although current artificial intelligence (“AI”) algorithms harness this data to provide knowledge-based predictive information and present the predicted information to one or more end-users, much of the stored data is unusable to an artificial intelligence engine. Artificial intelligence engines are unable to process much of the data into information that is usable to an end user.

Therefore, it would be desirable to provide an artificial intelligent engine that is able to process stored data into information graphs by creating connections between data elements. It would be yet further desirable for these graphs to be used to identify end-to-end paths such as input to target paths that are fully explainable using the connections/relationships.

### SUMMARY OF THE DISCLOSURE

Systems, apparatus and methods for a graph investigation and identification system are provided. The system may include a processor. The processor may receive a matrix of integers. The matrix of integers may correspond to a plurality of attributes. The matrix of integers may be stored as a sparse matrix.

The processor may receive a matrix of Booleans. The matrix of Booleans may correspond to a plurality of available targets. The matrix of Booleans may be stored as a sparse matrix.

The processor may link integers, included in the matrix of integers, to targets, included in the matrix of Booleans. It should be noted that an integer may be linked to a Boolean through one or more other integers or Booleans within the matrix of integers and/or the matrix of Booleans.

The processor may receive an initial starting index into the matrix of integers and the matrix of Booleans. The initial starting index may point to a location within the matrix of integers and/or the matrix of Booleans.

The processor may receive a gain function. The gain function may define whether joining an attribute to an entity provides more information or removes information from a graph.

The following describes an exemplary gain function. F, y, and ŷ may be used define a gain for many objective functions.

For each point, a gain or loss function of y and ŷ(x) may be approximated up to second order using Taylor Series. x may represent the matrix of integers. y may represent the matrix of Booleans.

For half of mean-squared error, the gradient of the nth point is gₙ=(ŷₙ−yₙ) and the Hessian is hₙ=1.

f scales a binary function's output by a. For example, return a when x>42 and 0 otherwise.

$$\frac{f ( x , m )}{a} = \{ \begin{matrix}1 , & m ( x ) = True \\ 0 , & m ( x ) = False\end{matrix}$$

To extremize gain or loss, one may take the derivative with reference to fand set the equation to equal zero.

The gradient and Hessian can be summed over multiple points.

Let

$${F}_{n , m} = \frac{f ( {x}_{n} , m )}{{a}_{m}}$$

be a matrix summarizing N data points and M operator choices.

$$Then G = {F}^{T} g and H = {F}^{T} h and 0 = {G}_{m} + {H}_{m} {a}_{m} {F}_{m} ⇒ {a}_{m} = - \frac{{G}_{m}}{{H}_{m}} .$$

If aₘ minimizes loss, that loss estimate is

$$k - \frac{{G}_{m}^{2}}{2 {H}_{m}}$$

where k is common to all m.

In this way, binary tests of x data imply weights for those tests that optimize some estimate of corresponding y.

Gradient boosting sequentially may select tests whose weights most optimize that function to improve ŷ(x).

As such, F^{T}(y−ŷ) may be used to capture reduction in error.

The processor may create an object. The object may include the matrix of integers, the matrix of Booleans, the initial starting index and the gain function.

The processor may initialize a first attribute within the object to an ordered list of mathematical objects. The ordered list of mathematical objects may include the matrix of integers and the initial starting index. The first attributes may include a variable pointer. The variable pointer may identify a variable location within the matrix of integers.

The processor may initialize a second attribute within the object to a data list.

The processor may create an array duplicating a layout of the matrix of Booleans. The processor may initialize each element within the array to false.

The processor may initialize a first element within the array to true. The first element may correspond to an initial stating index into the array. The initial starting index into the array may correspond to the initial starting index into the matrix of integers and the matrix of Booleans.

The processor may execute the following set of executable instructions. The processor may set an ordered attribute list to a list comprising keys of the first attributes. The processor may set a first variable to a function. The function may join elements of a plurality of arrays into a single array. The function may retrieve each element by the first attribute. The function may pair each element with one or more attributes included in the ordered attribute list. The function may generate a single array.

The processor may set a second variable to an outcome of the gain function processing the matrix of Booleans, the array and the first variable.

The processor may set a third variable to an outcome of an argmax operation processing the second variable. When the outcome of the second variable is greater than or equal to zero, the processor may end the set of executable instructions.

The processor may add a chosen attribute to the used attribute list. The chosen attribute may be identified by the third variable pointing to a location within the ordered attribute list.

The processor may remove the chosen attribute from the open attribute list. The processor may execute the following subprocess for each row included in the first attribute when a pointer is pointing to the chosen attribute. For each chosen attribute in range of the matrix of integers, when the chosen attribute is absent from both the open attribute list and the used attribute list, set the open attribute list to the chosen attribute.

The processor may set a pointer that identifies the chosen attribute within the array to true. The processor may return the second attribute. The processor may repeat the set of executable instructions. The processor may generate a graph. The graph may include nodes and edges. The nodes may represent entities included in the matrix of integers. The edges may represent attributes to link the entities. The plurality of entities may include one or more parties, behaviors and attributes.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows still another illustrative diagram in accordance with principles of the disclosure;

FIG. 5 shows yet another illustrative diagram in accordance with principles of the disclosure;

FIG. 6 shows still another illustrative diagram in accordance with principles of the disclosure;

FIG. 7 shows yet another illustrative diagram in accordance with principles of the disclosure;

FIG. 8 shows still another illustrative diagram in accordance with principles of the disclosure;

FIG. 9 shows yet another illustrative diagram in accordance with principles of the disclosure;

FIG. 10 shows still another illustrative diagram in accordance with principles of the disclosure;

FIG. 11 shows yet another illustrative diagram in accordance with principles of the disclosure;

FIGS. 12A and 12B show still another illustrative diagram in accordance with principles of the disclosure;

FIG. 13 shows yet another illustrative diagram in accordance with principles of the disclosure;

FIG. 14 shows still another illustrative diagram in accordance with principles of the disclosure;

FIG. 15 shows yet another illustrative diagram in accordance with principles of the disclosure;

FIG. 16 shows still another illustrative diagram in accordance with principles of the disclosure;

FIG. 17 shows yet another illustrative diagram in accordance with principles of the disclosure;

FIG. 18 shows still another illustrative diagram in accordance with principles of the disclosure;

FIG. 19 shows yet another illustrative diagram in accordance with principles of the disclosure;

FIG. 20 shows still another illustrative diagram in accordance with principles of the disclosure;

FIG. 21 shows yet another illustrative diagram in accordance with principles of the disclosure;

FIG. 22 shows yet another illustrative diagram in accordance with principles of the disclosure.

FIG. 23 shows still another illustrative diagram in accordance with principles of the disclosure.

FIG. 24 shows still yet another illustrative diagram in accordance with principles of the disclosure.

### DETAILED DESCRIPTION OF THE DISCLOSURE

Apparatus, methods and systems for linking entities from within a plurality of entities is provided.

Methods may use one or more elements of the following exemplary inputs, exemplary outputs and code:

Inputs:

```
X, an N × Dₓ+1 matrix of integers
  N: number of distinct data examples
  Dₓ : number of non-index attributes
  The first column must be a unique index
y, an N × D_{y} matrix of Booleans
  D_{y} : number of targets (e.g., entities)
init, A starting index into X and y
gain(y, ŷ, F), a gain function
  Can be simple: E.g. ( (y − ŷ) @ F ).sum(0)
```

Raw Outputs:

A list of (integer, column #) tuples
E.g., “Address = 123 ABC Street”

Code:

```
def Search (X,y, init, gain):
  openAttr = { tuple( X[init, c], c ): X[:, c] == X[init, c] for c in range(1, Dₓ + 1) }
  usedAttr = set{ tuple(init, 0) }
  yhat = an array “like” y, but initialized to False
  yhat[init, :] = True
  while True: # Do-while
    orderedAttr = list( openAttr.keys( ) )
    F = vstack( openAttr[a] for a in orderedAttr )
    gains = gain(y, yhat, F)
    chosen = gains.argmax( )
    if gains[chosen] <= 0: break
    usedAttr.add( orderedAttr[chosen] )
    openAttr.pop( orderedAttr[chosen] )
    foreach row, r, where F[:, chosen] == True:
      for c in range(1, Dₓ + 1):
        if tuple(X[r, c], c) in neither openAttr nor usedAttr:
          openAttr[ tuple( X[r, c], c ) ] = X[:, c] == X[r, c]
    yhat[ F[:, chosen], ] = True
  return usedAttr
```

Methods may include receiving a matrix of integers. Methods may include receiving a matrix of Booleans. Methods may include receiving an initial starting index into the matrix of integers and the matrix of Booleans. Methods may include receiving a gain function. Methods may include creating an object. The object may include the matrix of integers, the matrix of Booleans, the initial starting index and the gain function.

Methods may include initializing a first attribute within the object. The first attribute may indicate an open attribute list. The first attribute may be initialized to an ordered list of mathematical objects, such as a tuple. The ordered list of mathematical objects may include the matrix of integers and the initial starting index into the matrix of integers and the matrix of Booleans. The first attribute may identify a variable within the matrix of integers.

Methods may include initializing a second attribute within the object. The second attribute may indicate a used attribute list. The second attribute may be set to a data list. The data list may include the initial starting index.

Methods may include initializing an array. The array may duplicate a format of the matrix of Booleans. Each element within the array may be initialized to false.

Methods may include initializing a first element within the array to true. The first element may correspond to an initial starting index into the array. The initial starting index into the array may correspond to the initial starting index into the matrix of integers and the matrix of Booleans.

Methods may include performing the following set of repeating executable instructions. It should be noted that the set of repeating executable instructions may be repeated until each element within the matrix of integers is processed.

The set of executable instructions may include setting an ordered attribute list to a list comprising keys of the first attribute. The set of executable instructions may include setting a first variable to a function. The function may join elements of the plurality of arrays into a single array. The function may retrieve each element identify by the first attribute. The function may pair each element with one or more attributes included in the ordered attribute list. The function may generate a single array.

The set of executable instructions may include setting a second variable to a result. The result of the gain function may receive the matrix of Booleans, the array and the first variable.

The set of executable instructions may include setting a third variable to a result of an argmax function executed on the second variable.

The set of executable instructions may include exiting the set of repeating executable instructions. The exiting may be executed when the result of the second variable is greater than or equal to zero.

The set of executable instructions may include adding a chosen attribute to the used attribute list. The chosen attribute may be identified by the third variable pointing to a location within the ordered attribute list.

The set of executable instructions may include removing the chosen attribute from the open attribute list. The set of executable instructions may include performing a second set of executable instructions for each row in the first attribute when a pointer is pointing to the chosen attributes. The second set of executable instructions may include for each chosen attribute in range of the matrix of integers, when the chosen attribute is absent from the open attribute list and the used attribute list, setting the open attribute list to the chosen attribute.

The set of executable instructions may also include setting the pointer that identifies the chosen attribute within the array to true. The set of executable instructions may include returning the second attribute. The returned second attribute may be a list of integers and column numbers. For example, the list may include the following: address is equivalent to 123 ABC Street. The list may connect a first entity to a second entity using the address. As such, the first entity and the second entity may share the address of 123 ABC street. The second attribute, or list of entities and connections may be used to generate a node and edge graph. The nodes within the graph may represent entities, while the edges within the graph may represent connections. The entities may include one or more parties, behaviors and attributes.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

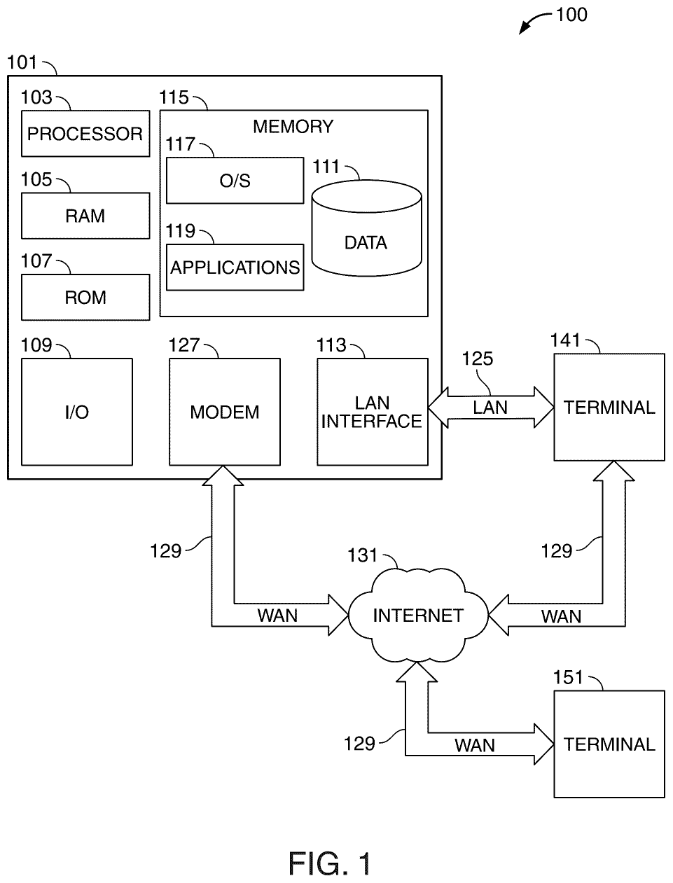

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smart phone, or any other suitable computing device. Elements of system 100, including computer 101, may be used to implement various aspects of the systems and methods disclosed herein. Each of the user telephones, mobile devices, user devices, databases and any other part of the disclosure may include some or all of apparatus included in system 100.

Computer 101 may have a processor 103 for controlling the operation of the device and its associated components and may include Random Access Memory (“RAM”) 105, Read Only Memory (“ROM”) 107, input/output circuit 109 and a non-transitory or non-volatile memory 115. Machine-readable memory may be configured to store information in machine-readable data structures. The processor 103 may also execute all software executing on the computer—e.g., the operating system and/or voice recognition software. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application(s) 119 along with any data 111 needed for the operation of the system 100. Memory 115 may also store videos, text and/or audio assistance files. nodes, servers, computing devices, User telephones, user devices, databases and any other suitable computing devices as disclosed herein may have one or more features in common with Memory 115. The data stored in Memory 115 may also be stored in cache memory, or any other suitable memory.

Input/output (“I/O”) module 109 may include connectivity to a microphone, keyboard, touch screen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. When used in a LAN networking environment, computer 101 is connected to LAN 125 through a LAN interface or adapter 113. When used in a Wide Area Network (“WAN”) networking environment, computer 101 may include a modem 127 or other means for establishing communications over WAN 129, such as Internet 131. Connections between System 100 and Terminals 151 and/or 141 may be used for the communication between different nodes and systems within the disclosure.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be configured to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (“SMS”) and voice input and speech recognition applications. Application program(s) 119 (which may be alternatively referred to herein as “plugins,” “applications,” or “apps”) may include computer executable instructions for invoking functionality related to performing various tasks. Application programs 119 may utilize one or more algorithms that process received executable instructions, perform power management routines or other suitable tasks. Application programs 119 may utilize one or more decisioning processes.

Application program(s) 119 may include computer executable instructions (alternatively referred to as “programs”). The computer executable instructions may be embodied in hardware or firmware (not shown). Computer 101 may execute the instructions embodied by the application program(s) 119 to perform various functions.

Application program(s) 119 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage and process data (e.g., “cloud computing” and/or “fog computing”).

Any information described above in connection with data 111 and any other suitable information, may be stored in memory 115. One or more of applications 119 may include one or more algorithms that may be used to implement features of the disclosure comprising the transmission, storage, and transmitting of data and/or any other tasks described herein.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, tablet, smartphone, or any other computing system for receiving, storing, transmitting and/or displaying relevant information. Terminal 151 and/or terminal 141 may be one or more data sources or a calling source. Terminals 151 and 141 may have one or more features in common with apparatus 101. Terminals 115 and 141 may be identical to system 100 or different. The differences may be related to hardware components and/or software components.

The invention may be operational with numerous other general purpose or special purpose computing system environments or configurations. Examples of well-known computing systems, environments and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices and the like.

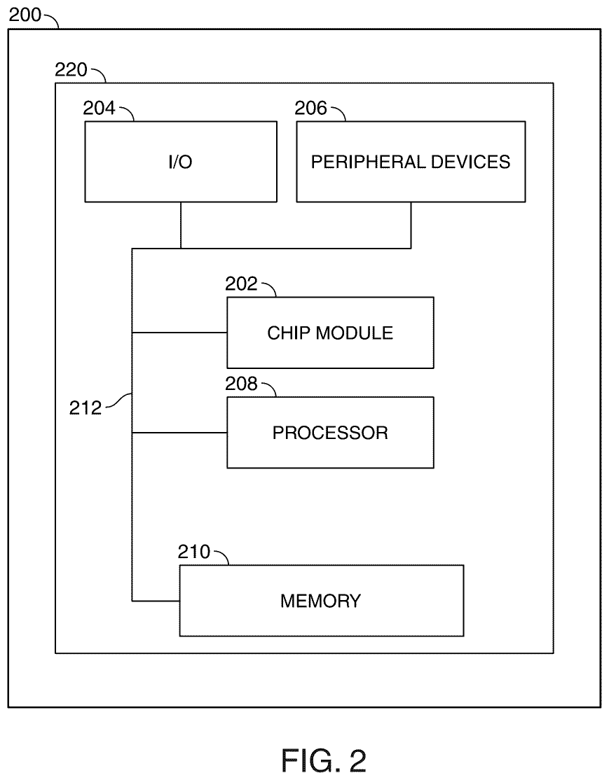

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

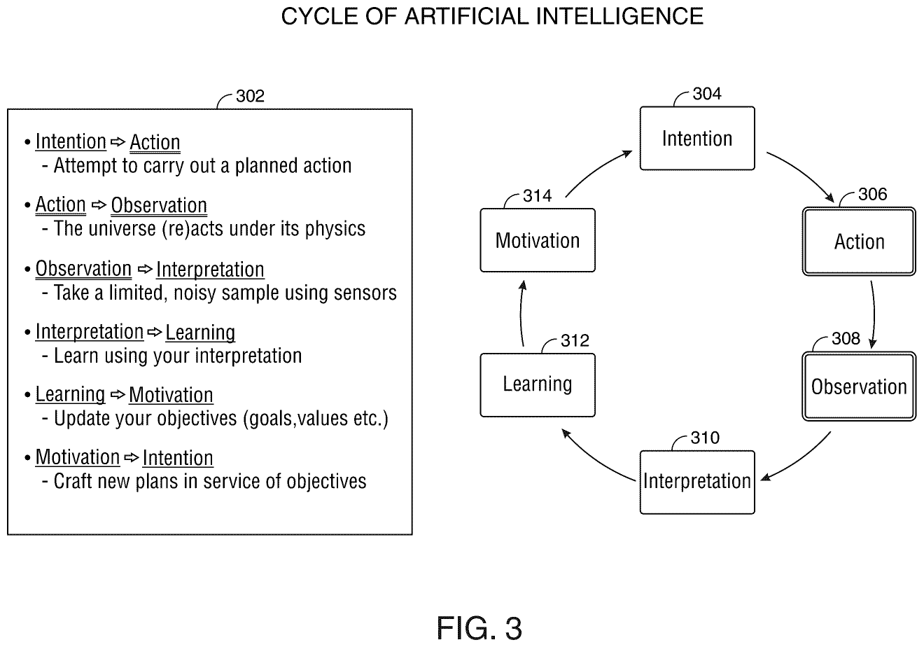

FIG. 3 shows an illustrative diagram. The illustrative diagram shows a cycle of artificial intelligence. The cycle of artificial intelligence includes multiple steps. Each step may lead to another step. The description of the process may be included in text box 302. Steps 304-314 may each be components of the artificial intelligence cycle.

Step 304 shows an intention. Step 306 shows an action. The transition between intention and action may be an attempt to conduct a planned action.

Step 308 shows an observation. The transition between action and observation may be a reaction of the universe to the action. The universe may operate under the laws of physics.

Step 310 shows an interpretation. The transition between observation and interpretation may be taking a limited, noisy sample using sensors.

Step 312 shows learning. The transition between interpretation and learning shows learning using the interpretation.

Step 314 shows motivation. The transition between learning and motivation shows updating the objectives. Objectives may include goals, values as well as any other suitable objectives.

The transition between motivation and intention shows crafting or creating new plans in service of objectives.

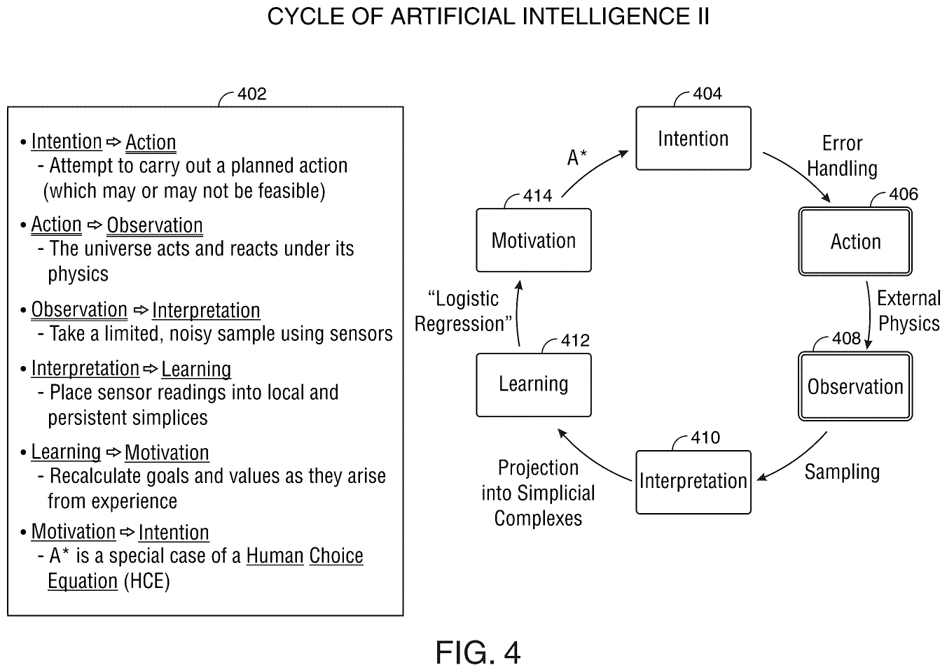

FIG. 4 shows an illustrative diagram. The illustrative diagram shows information regarding the cycle of artificial intelligence. The steps shown at 404-414 may be the same steps shown at 304-314. Text box 402 may explain the transition between steps 404 and 414.

The transition between intention and action may be an attempt to conduct a planned action, which may or may not be feasible. The transition between intention and action may include error handling.

The transition between action and observation may include the universe reacting based on physics. The transition between action and observation may include external physics.

The transition between observation and interpretation may include taking a limited, noisy sample using sensors. The transition between observation and interpretation may include sampling.

The transition between interpretation and learning may include placing sensor reading into local and persistent simplices. The transition between interpretation and learning may include projection into simplicial complexes. As such, the samples may be projected into simplicial complexes.

The transition between learning and motivation may include recalculating goals and values as the goals and values arise from experience. The transition between learning and motivation may include regression algorithms such as logistic regression. Logistic regression may predict probability values through a logistic function.

The transition between motivation and intention may include the A star (“A*”) algorithm. The A* algorithm may be a special case of a Human Choice Equation (“HCE”). A* star algorithm may be a graph traversal and pathfinding algorithm that finds the shortest path from the source to the goal traversing the fewest number of nodes.

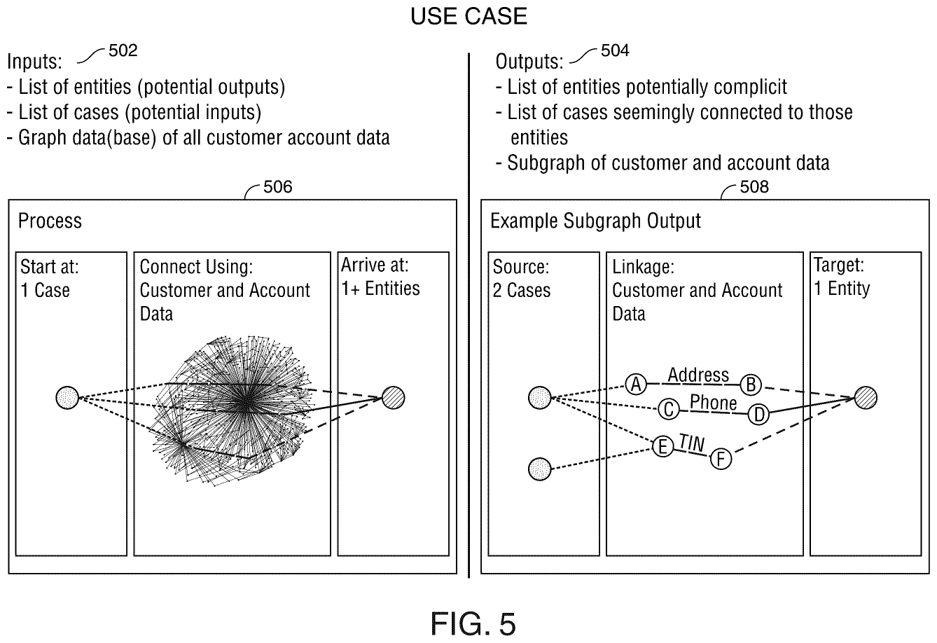

FIG. 5 shows an illustrative diagram. The illustrative diagram shows an illustrative use case of an investigation system. The illustrative diagram shows a plurality of inputs (502) and a plurality of outputs (504).

The plurality of inputs (502) may include a list of entities. Each of the entities may be potential outputs. The plurality of inputs may include a list of cases. Each of the cases may be potential inputs. The plurality of inputs may include graph data (or database) of all customer account data. The graph data may be used to connect a case to one or more entities.

The plurality of outputs (504) may include a list of entities. The output list of entities may be a subset of the list of entities entered in the inputs. The output list of entities may be potentially complicit entities. The plurality of outputs may also include a list of cases connected, above a threshold percentage, to the output list of entities. The output list may also include a subgraph of customer and account data.

The process for creating a graph may be shown at 506. The process may include starting with a first case. The first case may include one or more evidence elements. The one or more evidence elements may indicate complicity. The first case may connect with other nodes within a graph using customer and account data. The first case may arrive at one or more entities. It should be noted that additional outputs, such as additional cases may also be included as outputs.

An exemplary subgraph output may be shown at 508. The subgraph may include two source cases, a plurality of linkages and a target entity. The plurality of linkages may include customer and account data, such as an address, phone number and a tax identification number (“TIN”).

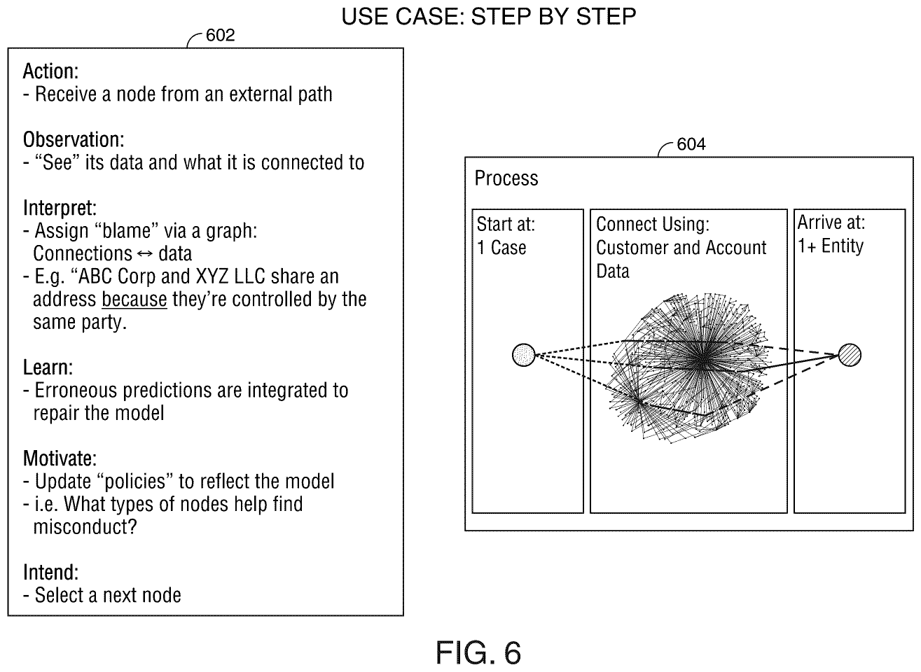

FIG. 6 shows an illustrative diagram. The illustrative diagram includes a step-by-step use case for the process shown at 604. Text box 602 includes the steps shown in FIGS. 3 and 4.

An action may include receiving a node from an external path. An observation may include seeing the node's data and to what the node's data is connected. An interpretation may include assigning “blame” via a graph. Assigning “blame” via a graph may include identifying connections that connect one data element to another data element. For example, ABC corporation and XYZ LLC share an address because both ABC corporation and XYZ LLC may be controlled by the same party.

A learning experience may include identifying whether the assumed assigned relationships (predictions) are correct. The learning experience may include integrating erroneous predictions into an artificial intelligence model to repair the model to generate predictions with greater accuracy in the future. The learning experience may be similar to gradient boosting; however, learning may replace threshold comparison tests with convex hull outsideness.

A motivation may include updating policies to reflect the model. For example, motivation may include identifying types of nodes are useful (or informational) in identifying misconduct or complicity.

An intention may include selecting the following node.

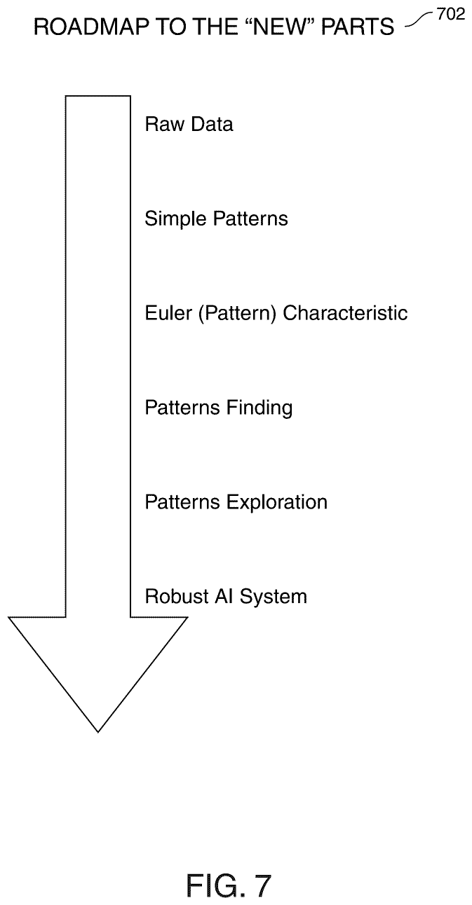

FIG. 7 shows an illustrative diagram. The illustrative diagram includes a roadmap to new parts, as shown at 702. The roadmap includes raw data which may be manipulated to generate simple patterns. The simple patterns may be used to identify Euler (pattern) characteristic. The Euler characteristic may be used to find patterns. The patterns may be explored. The explored patterns may be used to create a robust artificial intelligence system.

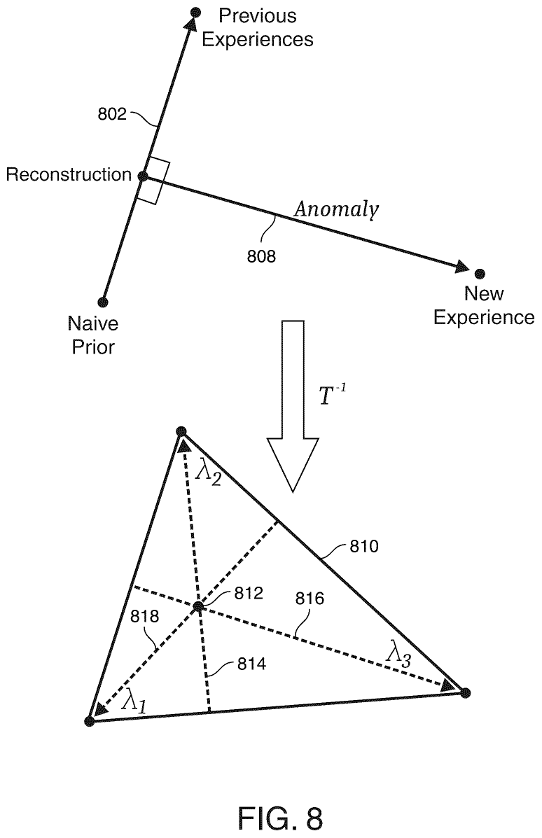

FIG. 8 shows an illustrative diagram. The diagram shows a naïve prior. It should be noted that any other suitable prior may be used in such an example. The naïve prior may be projected onto previous experiences, as shown at 802. When the naïve prior is projected onto previous experiences, which may be referred to as reconstruction, a reconstruction error value may be generated. It should be noted that the reconstruction error value may be the value in which the new experience does not match any previous experiences. As such, the reconstruction error value may identify the new experience, as shown at 808.

Point a, shown at λ₁, may indicate the naïve prior, point b, shown at λ₂, may indicate the previous experience and point c, shown at λ₃, may indicate the new experience. A line segment from the naïve prior to the previous experiences may be encoded by a neuron. The point of reconstruction may represent the new experience projected onto line segment that encodes the naïve prior to the previous experiences. The line segment that encodes the reconstruction anomaly to the new experience, as shown at 808, may be represented by a neuron that may encode the reconstruction to the new experience.

The line segments may be transformed into a simplex using the following method: generate a coactivation matrix of line segments: naïve prior to previous experiences and reconstruction anomaly to new experience; invert the coactivation matrix to generate an inverse coactivation matrix; multiply the weights of the neurons by the inverse coactivation matrix; this may convert the neurons from neurons that encode anomalies to neurons that encode a simplex. The thresholds may be recalculated.

Another method may be as follows: take points λ₁, λ₂ and λ₃, push points λ₁, λ₂ and λ₃ through the neurons that encode point λ₁, line segment naïve prior to previous experiences and line segment reconstruction anomaly to new experience to generate a coactivation matrix. The coactivation matrix may be inverted. The coactivation matrix inverse may be multiplied by the weight matrix to yield a weight prime matrix. In order to get a threshold prime, one can solve for point: λ₁, maximizing the λ₁ neuron, point λ₂ maximizing the λ₂ neuron and point λ₃ maximizing the λ₃ neuron. The result may be the simplex, or combination space.

Dotted lines 814, 816 and 818 show the definition of the combination space, from a corner of the simplex to the opposite line.

Point 812 shows the middle point of the simplex. A data point that is plotted in the middle of the simplex corresponds to a maximally unsure model. An example of a data structure that may be plotted at point 812, may be a data structure that has 33.33% correspondence to point λ₁, 33.33% correspondence to point λ₂, 33.33% correspondence to point λ₃.

As shown in FIG. 8, the system may use Foliated Simplicial Complexes. Foliated Simplicial Complexes may be convex hulls with some additional conditions that let complexes serve as a coordinate system. As such, note the following:

$${λ}_{ABC} ( A ) = ( 1 , 0 , 0 ) ∀ A , B , C$$

$$\sum {λ}_{n} ( x ) = 1 ∀ x$$

Σ|λₙ(x)|>1 only if x is outside the hull.

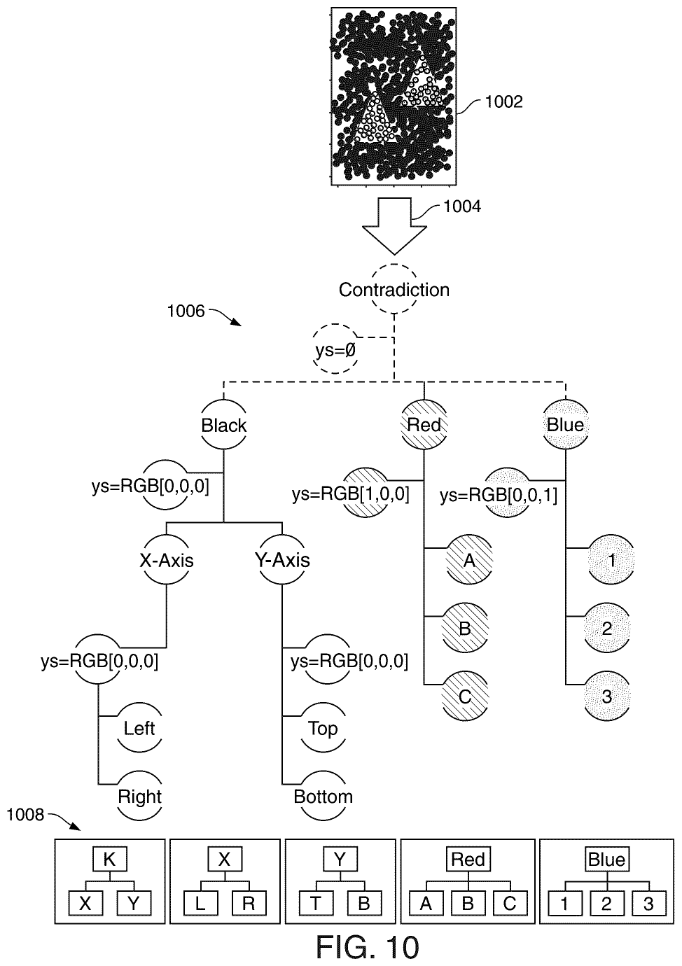

The A may identify closed-form neurons and deep complexes may be flattened, as shown later in FIG. 10. Outsideness of a 1-point hull may be an inequality test.

A Python dictionary may serve as a λ that performs equality tests and returns pointers. λ can be referred to as a dictionary. For example, ŷ=y_{ABC}·λ_{ABC}(x). λ may also interpolate.

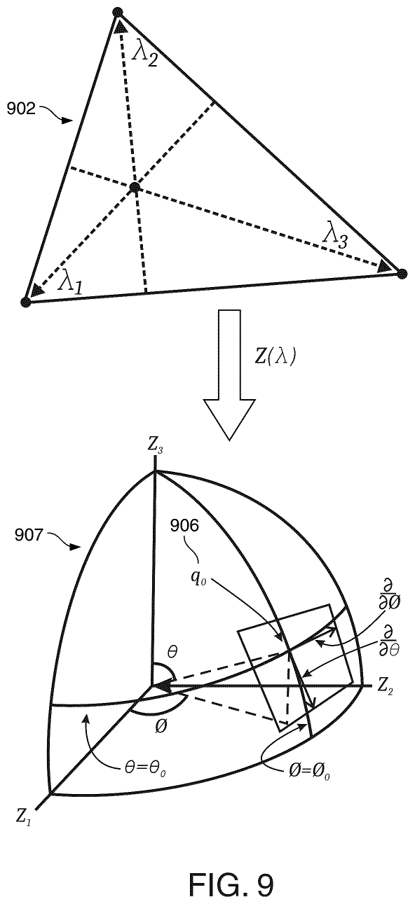

FIG. 9 shows an illustrative diagram.

Distance in z may be distance for probability and similar measures. The following set of equations L may describe the transformation.

$${z}_{n} = R \sqrt{{λ}_{n}}$$

The z corresponding to A may a sphere of radius R.

Derive Logistic Regression from Centripetal Acceleration's Integral when N=2:

$${a}_{c} = ( {∇}_{λ}^{2} z ) \cdot \hat{u} = \frac{- 4}{R {λ}_{0} {λ}_{1}} = \frac{- 4}{R {λ}_{0} ( 1 - {λ}_{0} )}$$

where û=z/R is a unit outward normal.

$$q = \int {a}_{c} d {λ}_{0}$$

$$q = \frac{4}{R} ln \frac{{λ}_{0}}{1 - {λ}_{0}} ⇒ λ = \frac{1}{1 + {e}^{\frac{4 q}{R}}}$$

The turning measure—q, may measure identity transformation.

The illustrative diagram shows a transformation (Z(λ)). The transformation transforms triangle 902 (which may be identical to triangle 810) into sphere 907. Upon transformation, q₀, may measure the integral of the centripetal acceleration with respect to probability. As such, q₀ measures the identity transformation, which may be the change in respect to new information. As such, the following executable steps may be used to identify whether a newly received data element is helpful or harmful.

For a path, take qₚ=Σₑ max (0, qᵣ−q_{f(e)}) and qᵣ as identity uncertainty of node number 0.

H may be simple for complicit identification: either the account(s) have interacted with an entity, or the accounts did not interact with the entity.

H(p) may be an increase in q_{f(e)} to an entity via shared interaction. A count function may be used to identify the increase. Disjoint union nodes may be used to make the triangle inequality hold.

In the following equation, f may represent the newly addable data element. Win may represent a data element that is sure to be helpful. Relevant may represent a data element that is relevant. Random element may represent the random probability that the data element is relevant.

$${q}_{f} = \{ q ( win ) - q ( win \vert naively ) \} + \{ q ( relevant ) - q ( random element is relevant ) \} \qquad Equation A$$

Equation A′ may be a variation of Equation A.

One step in a potentially long path:{Q(51%)−q(50%)}+{(q(100%)−q(1 in a million))} Equation A′

It should be noted that the A* algorithm selects the best possible nodes (meaning the ones that are most helpful) in getting from a source to a target.

The following variations may be made to an A* algorithm:

Path reconstruction may motivate a large amount of the function of A*. For example, a node can be a path and use no reconstruction. Nodes may denote more elemental paths. Costs in conditional entropy conveniently sum to a total conditional entropy, with quirks.

Once a shortest path is found, the process may stop if the processes' total cost exceeds some value. The system returns the union of all node-paths found below that value. Unique elemental nodes and their unique edges may be returned as well.

A path that is successfully connected to a solution may be excluded to avoid reuse. Every adjacent node that can be added without exceeding the remaining cost budge must be added for completeness. The terminal node may be deleted from the working copy of the graph, which may initiate re-computation of the heuristic used for A*.

FIG. 10 shows an illustrative diagram. The illustrative diagram shows a process from graph 1002 which develops into complex 1006 (indicated by arrow 1004) which develops into neural network 1008. Neural network 1008 may be a flattened neural network and used to process additional data graphs and/or elements.

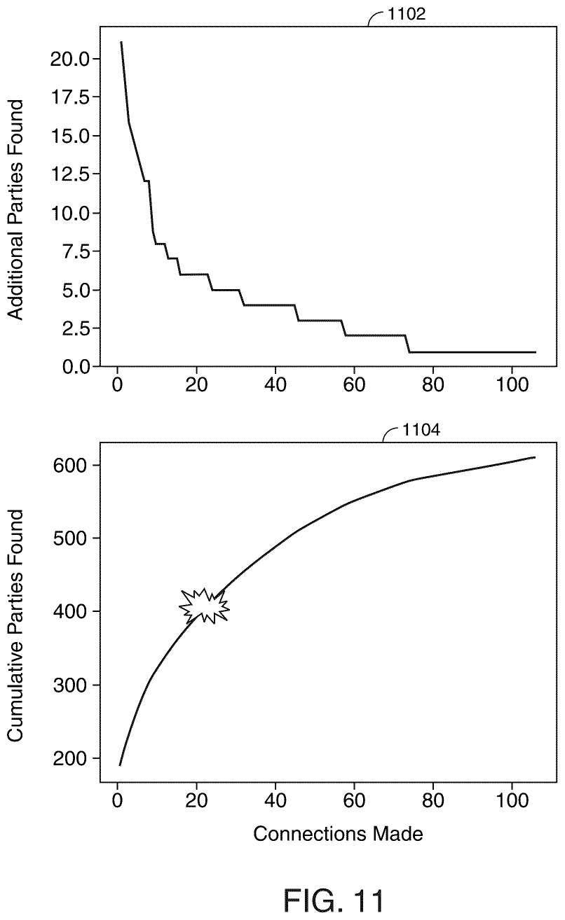

FIG. 11 shows an illustrative diagram. The illustrative diagram includes graph 1102 and graph 1104. Graph 1102 shows a number of parties found based on a number of connections made. As such, the more connections, or linkages made between nodes on a graph, the more parties, or entities, may be pulled into the graph. After 78 parties were found in a particular search, additional connections may not assist in identifying additional parties.

Graph 1104 shows a number of cumulative parties found based on a number of connections made. As shown in graph 1104, 400 cumulative parties may be identified using twenty connections.

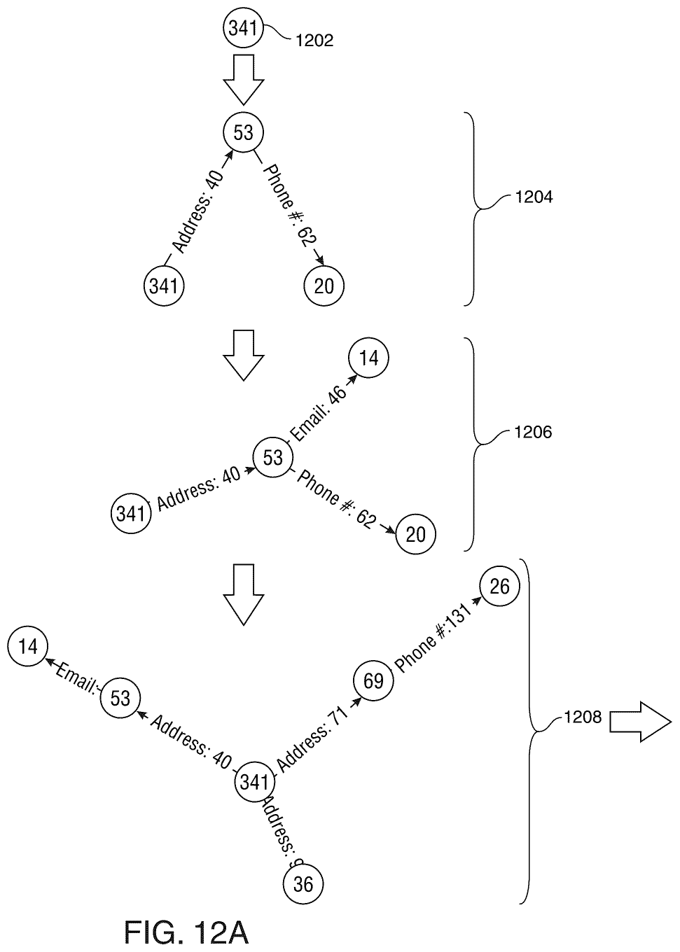

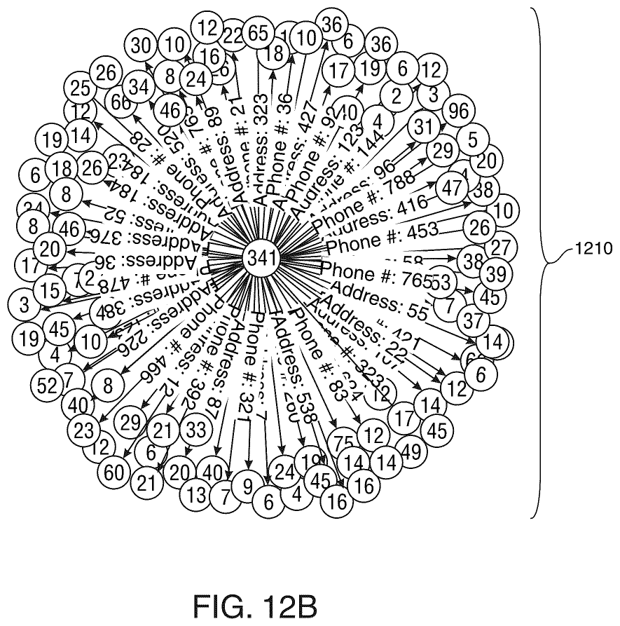

FIGS. 12A and 12B show an illustrative diagram. The illustrative diagram shows a process for connecting parties with other parties using connections.

Party number 341, shown at 1202, may be identified as a complicit entity, or been involved in a complicity activity.

As shown at 1204, party number 341 may be linked to party number 53 because party number 341 and party number 53 share an address. Also, party number 53 may be linked to party number 20 because party number 53 and party number 20 share a phone number.

As shown at 1206, party number 14 may be linked to party number 53 because party number 14 and party number 53 may share an email address.

As shown at 1208, party number 36 may be linked to party number 341 because party number 341 and party number 36 may share an address. Party number 341 may be linked to party number 69 because party number 341 and party number 69 may share an address. Party number 69 may be linked to party number 26 because party number 69 and party number 26 may share a phone number.

As shown at 1210, party number 341 may be connected to multiple other parties because party number 341 may share attributes, such as identification attributes, behavior attributes, demographic attributes or any other suitable attributes with the multiple other parties.

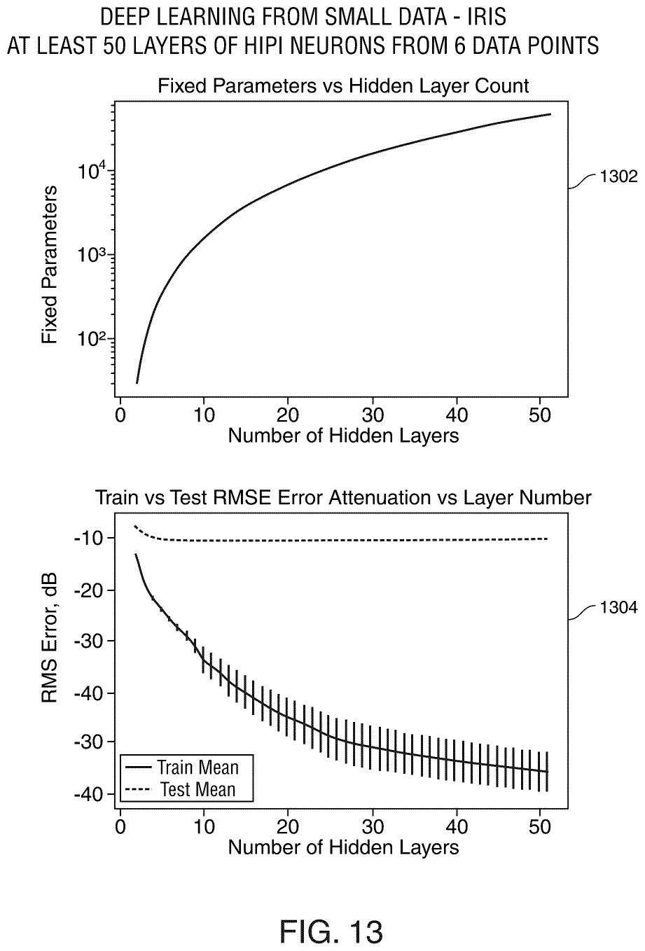

FIG. 13 shows an illustrative diagram. The illustrative diagram shows deep learning from small data. As shown, multiple layers of human inspired pattern identification (“HIPI”) neurons may be generated within a neural network using six data points. The search system may be able to productively fix over ten million parameters across more than fifty layers (within a neural network) from a small number of data points (such as six data points).

Graph 1302 shows the change in the number of hidden layers based on a number of fixed parameters.

Graph 1304 shows a train vs. test root mean square deviation (“RMSE”) Error Attenuation vs. Layer number. The X-axis shows the number of hidden layers. The Y-axis shows the root mean square (“RMS”) error.

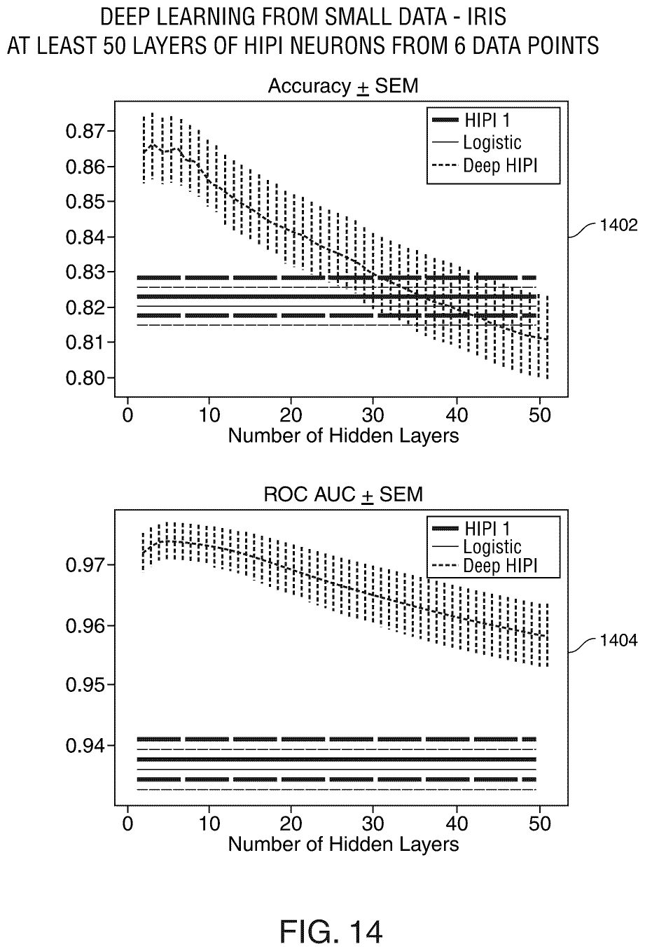

FIG. 14 shows an illustrative diagram. The illustrative diagram shows deep learning from small data. As shown, multiple layers of HIPI neurons may be generated within a neural network using six data points.

Graph 1402 shows an accuracy metric of a neural network based on the number of hidden layers. The accuracy metric shown may be plus or minus the standard error of the mean (“SEM”).

Graph 1404 shows a receiver operating characteristic (“ROC”) area under curve (“AUC”) for the number of hidden layers. It should be noted that ROC AUC may measure performance for a classification problem at various threshold settings. The ROC AUC may be shown plus or minus the SEM.

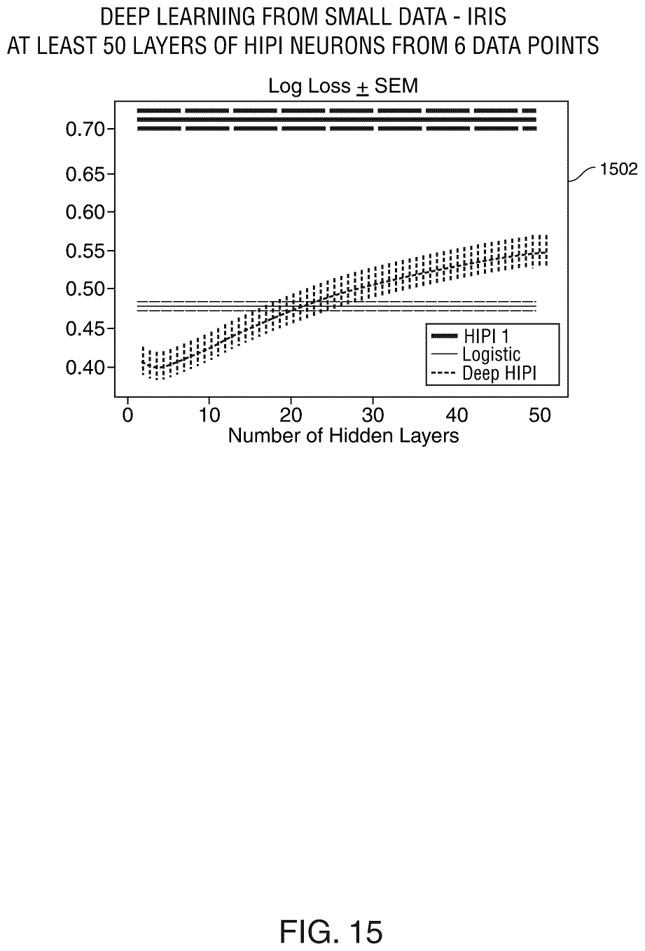

FIG. 15 shows an illustrative diagram. The illustrative diagram shows deep learning from small data. As shown, multiple layers of HIP neurons may be generated within a neural network using six data points.

Graph 1502 shows the log loss plus or minus the SEM based on the number of hidden layers. The log loss may be an evaluation measure to determine the performance of a classification model.

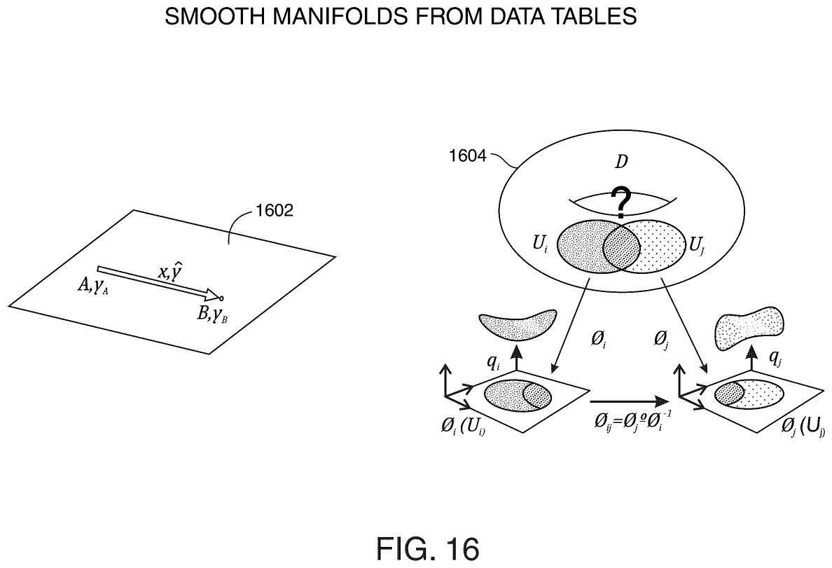

FIG. 16 shows an illustrative diagram. The illustrative diagram shows smooth manifolds from data tables. Flat coordinate systems, such as 1602, may be unable to capture substantially all perspectives of the data. As such, smooth manifolds may be used to view data from more perspectives. As such, instead of assigning coordinates to two data points, smooth manifolds enable coordinate-independent measurements of points and vectors. In an example, X, shown in 1602, may be 60% of the way from A to B. Path length may therefore be coordinate independent. However, path length may utilize a metric.

Manifolds, such as 1604, may support the addition of vectors and scaling of vectors. Weighted averages may be useful and use adding and scaling. The following set of equations may be used to create smooth manifolds from data tables.

$$\hat{y} = {λ}_{A} ( \vec{x} ) {y}_{A} + {λ}_{B} ( \vec{x} ) {y}_{B} \qquad Equation B$$

When n≠m: Σₙλₙ(x)=1, λₙ(\vec{x}ₙ)=1, and λₙ(\vec{x}ₘ)=0

Coordinates on the manifold may be relative, however, rows may not be relative. As, it may be determined that observations have an underlying source. Therefore, rows may be described as a weighted average, λₙ(\vec{x}), of other rows.

The following set of equations C shows a linear example for

$$y = \frac{2}{7} x + 3 :$$

$${x}_{A} = 0 , {y}_{A} = 3 , {x}_{B} = 7 , {y}_{B} = 5 \qquad Equation Set C$$

$${λ}_{A} = 1 - \frac{1}{7} x , {λ}_{B} = \frac{1}{7} x$$

$$\hat{y} = ( 1 - \frac{1}{7} x ) 3 + ( \frac{1}{7} x ) 5 = 3 + \frac{5 - 3}{7} x$$

When \vec{x} is a vector, λ_{A}=ReLU(1+\vec{x}·ω_{AB}−τ_{A})=RELU(1+ω_{AB}·(\vec{x}−\vec{x}_{A})

The co-vector, or weights,

$${ω}_{AB} = \frac{{\vec{x}}_{A} - {\vec{x}}_{B}}{{( {\vec{x}}_{A} - {\vec{x}}_{B} )}^{2}}$$

projects \vec{x} onto the line

The threshold, τ_{A}=ω_{AB}·\vec{x}_{A}, is chosen so that λ_{A}(\vec{x}_{A})=1 and λ_{A}(\vec{x}_{B})=0

It may be understood that rows form a local coordinate basis for other rows.

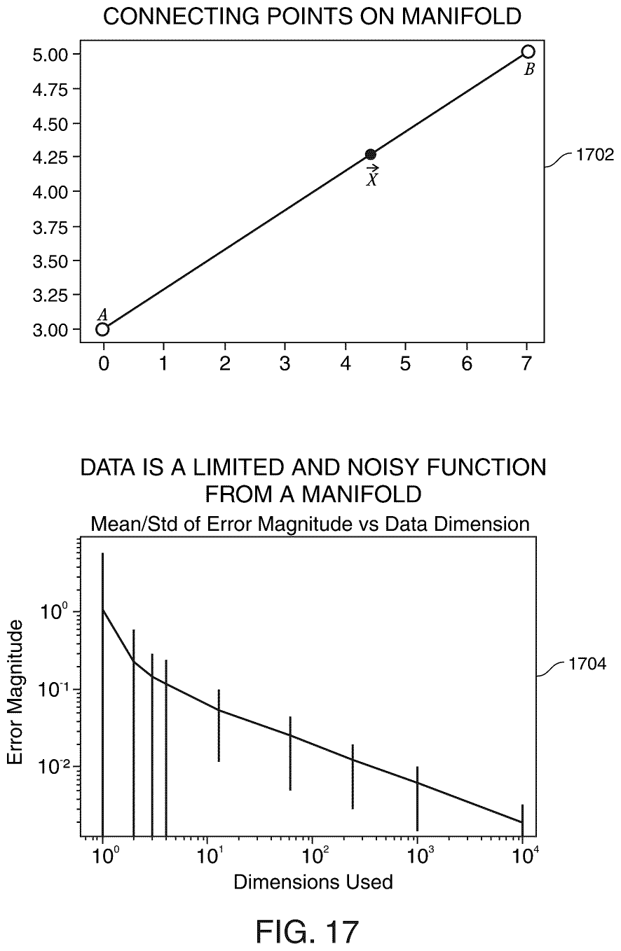

FIG. 17 shows an illustrative diagram. The illustrative diagram includes graph 1702 and graph 1704. Graph 1702 shows connecting points on manifold. Point A may be connected to point B using vector X.

Graph 1704 shows that data is a limited and noisy function from a manifold. Graph 1704 shows a mean/standard (“Std”) of error magnitude vs. data dimension. As shown, the more dimensions used, the smaller the magnitude of error.

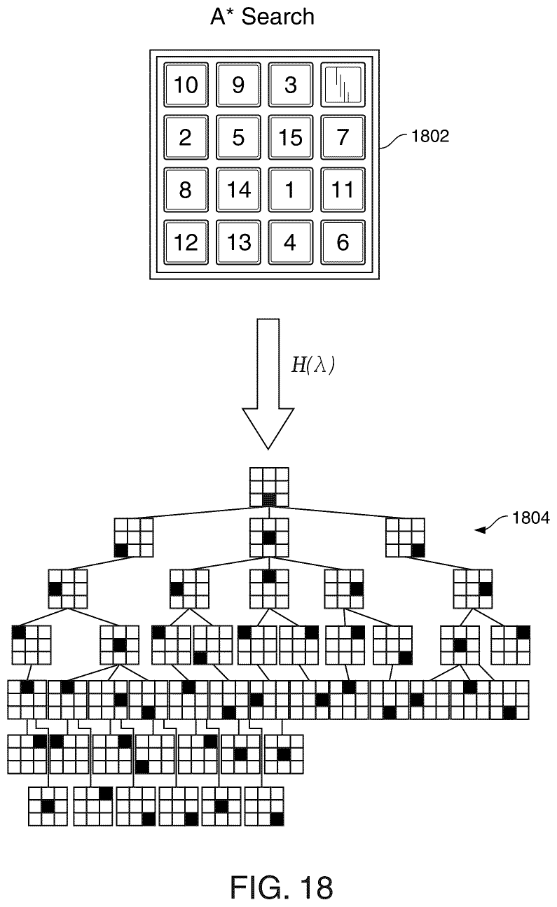

FIG. 18 shows an illustrative diagram. The illustrative diagram shows a searching algorithm (H(λ)) used to solve number cube 1802. Solving number cube 1802 may involve placing the cubes in numerical order. (H(λ)) may be a searching algorithm, such as an A star searching algorithm. The A star searching algorithm may create graph 1804 solve number cube 1802. The A star searching algorithm may minimize the number of wrong turns while solving number cube 1802.

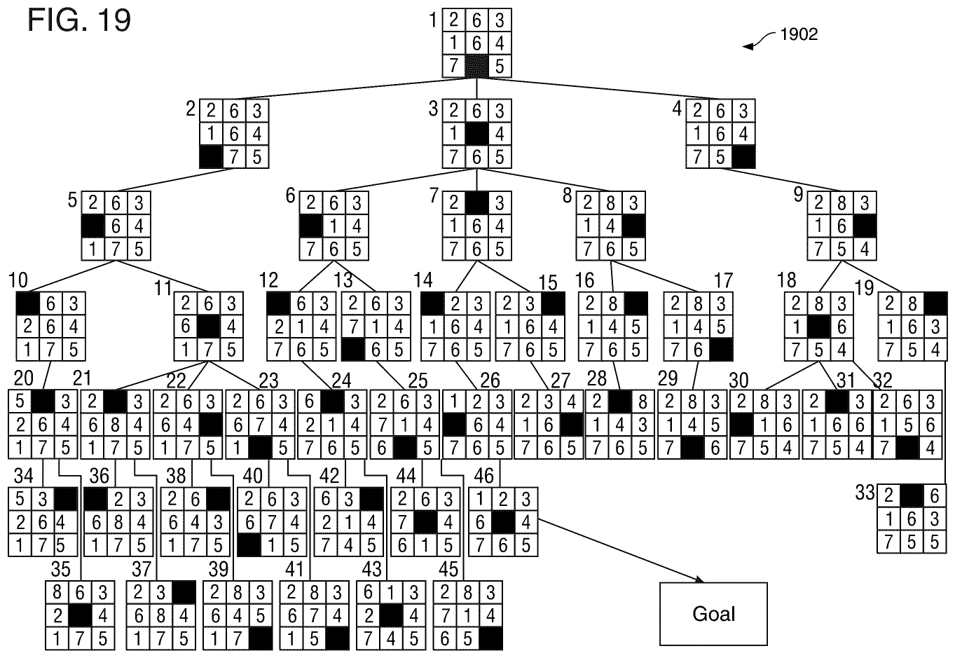

FIG. 19 shows an illustrative diagram. The illustrative diagram shows graph 1902. Graph 1902 shows a showing a partial solution to a number cube using an A star searching algorithm.

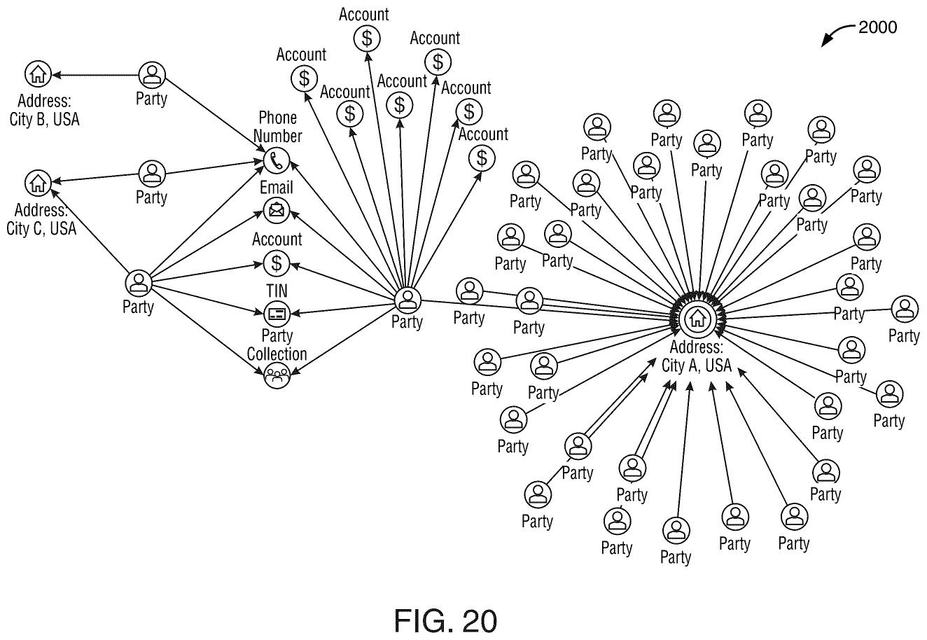

FIG. 20 shows an illustrative diagram. The illustrative diagram shows graph 2000. Graph 2000 shows multiple parties and attributes, including accounts, phone numbers, addresses, party collections, tax identification numbers (“TIN”) and email addresses. Graph 2000 shows the connections between the parties and the attributes.

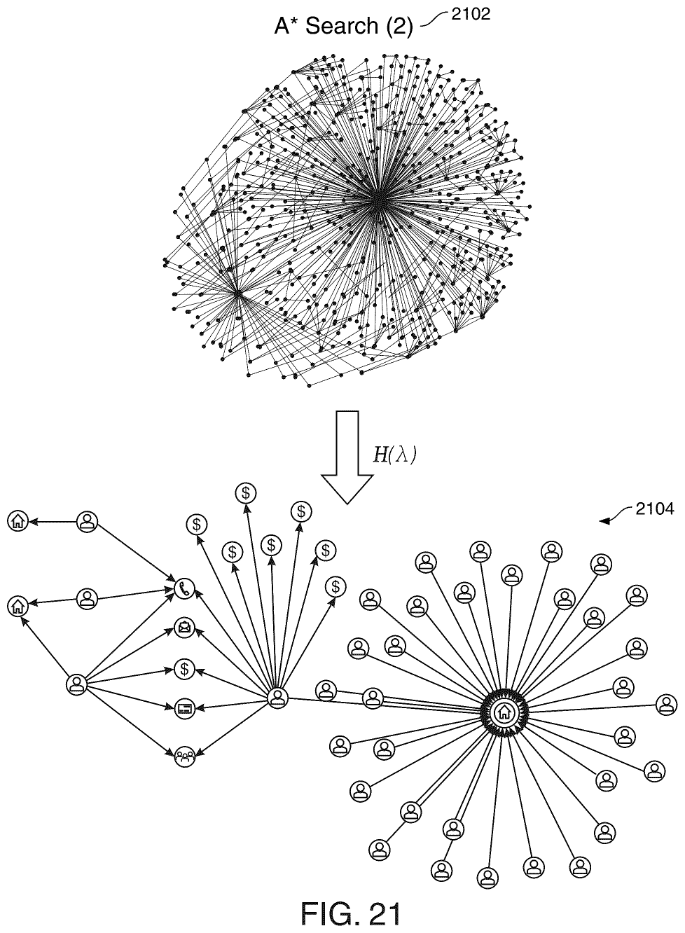

FIG. 21 shows an illustrative diagram. The illustrative diagram shows using an A star search algorithm (2102) to process a data set into graph 2104.

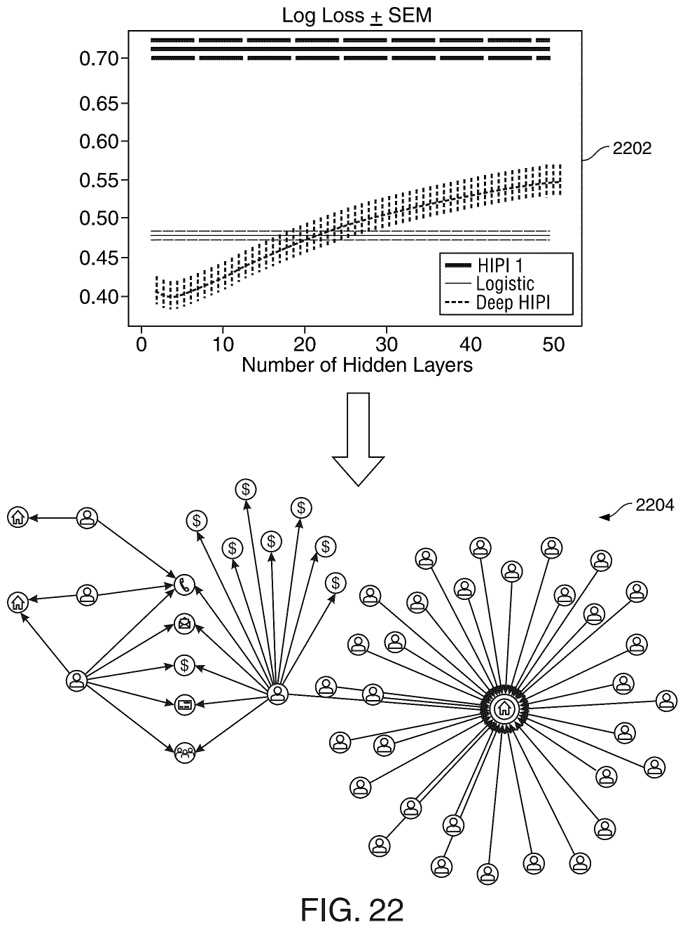

FIG. 22 shows an illustrative diagram. Categorical regression, shown in graph 2202, may naturally produce the functions for the q, which may be used to produce graph 2204.

Categorical Regression naturally produces functions for the q that may be used. The system may call conditional entropies q_{f} where the f could be a neural net or Refresh statistics. The system may set the cost of drawing a connection to max(0, qᵣ−q_{f}). As such, the cost of drawing a connection may enable the system to quantitatively engage in proof and deductive reasoning.

The system may draw connections a fixed error budget, such as qᵣ−q_{95%}≈6=3×2. The fixed error budget may use approximately two hops that are each an order of magnitude above pr.

Such a system is better than executing one or more JOINs on literal values because of the following. Data may include errors and erroneous values do not imply linkage. Additionally, it should be noted that certain columns have more error or less error than other columns, however, all columns may be treated equally in the system. Such a system may be better than mathematically proven strategies such as Belief Propagation because Belief Propagation has a problem which requires edges to decide if there should be an edge.

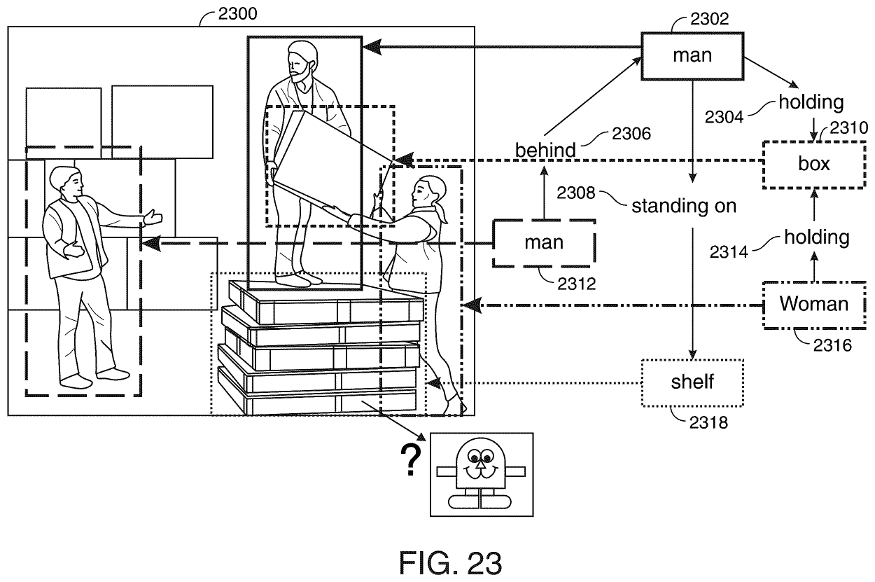

FIG. 23 shows an illustrative diagram. The illustrative diagram shows subgraph identification in a Scene Graph Exploration. Picture 2300 may be used to create a graph. The graph may include nodes 2302, 2310, 2312, 2316 and 2318. The graph may also include edges (or relationships between the nodes). The edges may include 2304, 2306, 2308 and 2314. It should be noted that the question mark on the bottom of the diagram indicates that there is a missing or unknown element. The missing or unknown element may be a second leg of woman 2316. However, the missing or unknown element may also be a leg of an additional person. As such, the system may assume, over a threshold, based on other experiences as to the indication of the missing or unknown element.

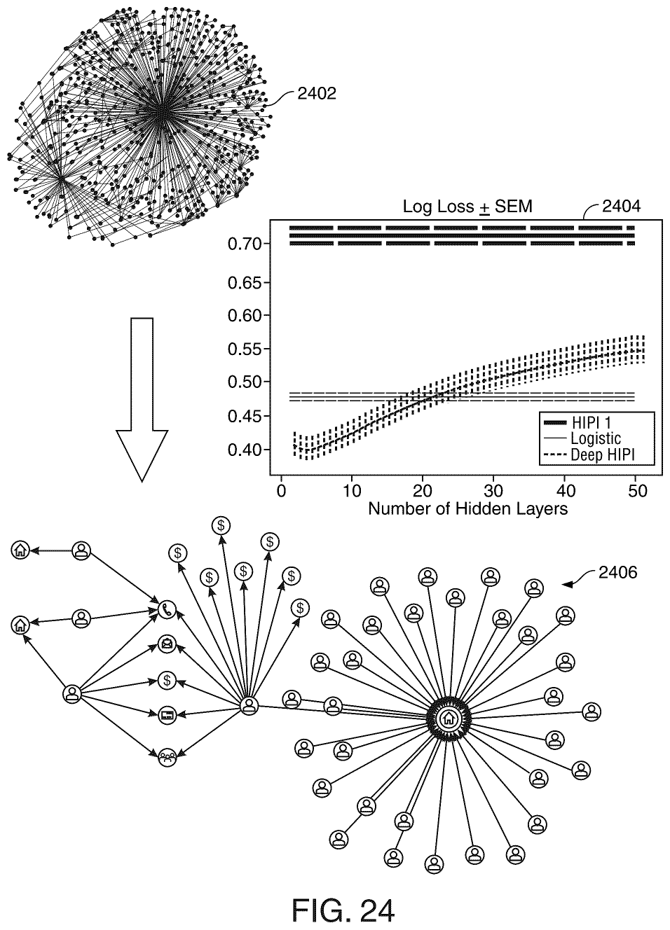

FIG. 24 shows an illustrative diagram. Data set 2402 may utilize graph 2404 (categorical regression) to produce a set of linked parties and attributes, shown at 2406.

Thus, systems and methods for a graph investigation and identification system are provided. Persons skilled in the art will appreciate that the present invention can be practiced by other than the described embodiments, which are presented for purposes of illustration rather than of limitation. The present invention is limited only by the claims that follow.

What is claimed is:

1. A method for linking entities from within a plurality of entities, the method comprising:
receiving a matrix of integers;
receiving a matrix of Booleans;
receiving an initial starting index into the matrix of integers and the matrix of Booleans;
receiving a gain function;
creating an object comprising the matrix of integers, the matrix of Booleans, the initial starting index and the gain function;
initializing a first attribute within the object, said first attribute indicating an open attribute list, said first attribute initialized to an ordered list of mathematical objects, said ordered list of mathematical objects comprising the matrix of integers and the initial starting index into the matrix of integers and the matrix of Booleans, said first attribute identifying a variable within the matrix of integers;
initializing a second attribute within the object, said second attribute indicating a used attribute list, said second attribute being set to a data list comprising the initial starting index;
initializing an array, said array duplicating a format of the matrix of Booleans, each element within the array being initialized to false;
initializing a first element within the array to true, said first element corresponding to an initial starting index into the array, said initial starting index into the array corresponding to the initial starting index into the matrix of integers and the matrix of Booleans;
performing the following set of repeating executable instructions:
setting an ordered attribute list to a list comprising keys of the first attribute;
setting a first variable to a function, said function joining elements of a plurality of arrays into a single array, said function retrieving each element identified by the first attribute and pairing each element with one or more attributes included in the ordered attribute list and generating a single array;
setting a second variable to a result, said result of the gain function receiving the matrix of Booleans, the array and the first variable;
setting a third variable to a result of an argmax operation executed on the second variable;
when the result of the second variable is greater than or equal to zero, exiting the set of repeating executable instructions;
adding a chosen attribute to the used attribute list, said chosen attribute identified by the third variable pointing to a location within the ordered attribute list;
removing the chosen attribute from the open attribute list;
performing the following for each row in the first attribute when a pointer is pointing to the chosen attribute:
for each chosen attribute in range of the matrix of integers:
when the chosen attribute is absent from the open attribute list and the used attribute list, set the open attribute list to the chosen attribute;
setting the pointer that identifies the chosen attribute within the array to true; and
returning the second attribute.

2. The method of claim 1 wherein the matrix of integers corresponds to a plurality of attributes.

3. The method of claim 1 wherein the matrix of Booleans corresponds to a plurality of available targets.

4. The method of claim 1 wherein the matrix of integers is stored as a sparse matrix.

5. The method of claim 1 wherein the matrix of Booleans is stored in memory as a sparse matrix.

6. The method of claim 1 wherein the plurality of entities comprises one or more parties, behaviors and attributes.

7. A graph investigation and identification system, the system comprising:
a processor, said processor operable to:
receive a matrix of integers;
receive a matrix of Booleans;
receive an initial starting index into the matrix of integers and the matrix of Booleans;
receive a gain function;
create an object, said object comprising the matrix of integers, the matrix of Booleans, the initial starting index and the gain function;
initialize a first attribute, within the object, to an ordered list of mathematical objects, said ordered list of mathematical objects comprising the matrix of integers and the initial starting index, said first attribute comprising a variable pointer, said variable pointer identifying a variable location within the matrix of integers;
initialize a second attribute, within the object, to a data list;
create an array duplicating a layout of the matrix of Booleans;
initialize each element within the array to false;
initialize a first element within the array to true, said first element corresponding to an initial starting index into the array, said initial starting index into the array corresponding to the initial starting index into the matrix of integers and the matrix of Booleans;
execute the following set of executable instructions:
set an ordered attribute list to a list comprising keys of the first attribute;
set a first variable to a function, said function joins elements of a plurality of arrays into a single array, said function:
retrieves each element by the first attribute;
pairs each element with one or more attributes included in the ordered attribute list; and
generates a single array;
set a second variable to an outcome of the gain function processing the matrix of Booleans, the array and the first variable;
set a third variable to an outcome of an argmax operation processing the second variable;
when the outcome of the second variable is greater than or equal to zero, end the set of executable instructions;
add a chosen attribute to the used attribute list, said chosen attribute identified by the third variable pointing to a location within the ordered attribute list;
remove the chosen attribute from the open attribute list;
execute the following subprocess for each row included in the first attribute when a pointer is pointing to the chosen attribute:
for each chosen attribute in range of the matrix of integers:
when the chosen attribute is absent from the open attribute list and the used attribute list, set the open attribute list to the chosen attribute;
set a pointer that identifies the chosen attribute within the array to true; and
return the second attribute;
repeat the set of executable instructions; and
generate a graph comprising nodes and edges, where the nodes represent entities included in the matrix of integers, and the edges represent attributes that link the entities.

8. The system of claim 7 wherein the matrix of integers corresponds to a plurality of attributes.

9. The system of claim 7 wherein the matrix of Booleans corresponds to a plurality of available targets.

10. The system of claim 7 wherein the matrix of integers is stored as a sparse matrix.

11. The system of claim 7 wherein the matrix of Booleans is stored in memory as a sparse matrix.

12. The system of claim 7 wherein the processor links one or more entities within a plurality of entities using one or more relationships.

13. The system of claim 12 wherein the plurality of entities comprises one or more parties, behaviors and attributes.

14. A method for identifying subsets of entities within a plurality of entities, the method comprising:
receiving indication of an action;
receiving a plurality of attributes;
receiving the plurality of entities;
using a search algorithm to link, using one or more selected attributes, included in the plurality of attributes, the action and/or one or more selected entities, included in the plurality of entities, to one or more other selected entities, included in the plurality of entities; and
creating a graph of the selected entities and the selected attributes, said plurality of entities corresponding to a plurality of nodes within the graph, said selected attributes corresponding to edges within the graph;
wherein:
each entity included in the selected entities is represented by a node on a graph; and
each attribute included in the selected attributes is represented by an edge on the graph.

15. The method of claim 14 wherein the search algorithm is A star search algorithm.

16. The method of claim 14 wherein the plurality of attributes is structured as a sparse matrix.

17. The method of claim 14 wherein the plurality of entities is structured as a sparse matrix.

18. The method of claim 14 wherein the indication of an action is a node from an external graph.

19. The method of claim 14 further comprising:
determining that one or more edges in the graph are erroneous; and
updating the search algorithm based on the determining that the one or more edges in the graph are erroneous.
